(19) United States
(12) Patent Application Publication
(10) Pub. No.: US 2026/0037331 A1
(43) Pub. Date: Feb. 5, 2026

(54) AUTHENTICATION SYSTEM FOR SECURE PRIVILEGED USER RESOURCE ACCESS

(71) Applicant: Truist Bank, Charlotte, NC (US)

(72) Inventors: Vianca Barlis Hernandez, Charlotte, NC (US); Yasmin Martinez, Atlanta, GA (US); Jonathan De los santos, Indian Trail, NC (US); Nina Greene, Raleigh, NC (US); Elysia Lam Truong, Brooklyn, NY (US)

(73) Assignee: Truist Bank, Charlotte, NC (US)

(21) Appl. No.: 18/794,413

(22) Filed: Aug. 5, 2024

(51) Int. Cl. G06F 9/50; H04L 9/40

(52) U.S. Cl. CPC G06F 9/5061; H04L 63/08; H04L 63/10; G06F 2209/5011

(57) ABSTRACT

Systems and methods receive and validate authentication credentials. A list of recommended contacts derived from stored user data associated with the stored authentication credentials are generated and transmitted to a user device for display. A request indicating contact(s) to be included in a shared resource pool that has a finite resource cap is received, where the shared resource pool is augmented in response to completion of objective(s). User request(s) initiating incorporating users in the shared resource pool are received and authentication credentials of the users are authenticated thereby granting access to the shared resource pool. A user records log of user contributions for completing the objective(s) is maintained and data used to initiate display of a progress status indicator representing completion of the objective(s) is updated. Once the finite resource cap is satisfied, resource(s) are distributed to user accounts of the users.

### FIELD

This invention relates generally to the field of user authentication, and more particularly embodiments of the invention relate to authentication systems for privileged access to user resources.

### BACKGROUND

User authentication is a critical component of maintaining privileged access in many digital systems. Authentication information can include any number of identifying information used to identify an individual such as usernames, passwords, biometric information, etc. Increasingly, digital systems use multi-factor authentication to further protect information. Improvements to existing authentication processes and digital systems are needed for various end-user applications.

### BRIEF SUMMARY

Shortcomings of the prior art are overcome and additional advantages are provided through the provision of a computing system for secure privileged user resource access authentication. The computing system includes at least one processor, a communication interface communicatively coupled to the at least one processor, and one or more memory devices storing executable code. Execution of the executable code causes the at least one processor to, at least in part, receive and validate authentication credentials of a user by comparing the authentication credentials to stored authentication credentials. Further, a list of recommended contacts for display is generated and transmitted to a user device, where the list of recommended contacts is derived from stored user data associated with the stored authentication credentials. A request to create a shared resource pool of resources that has a finite resource cap is received via a network from the user device, where the request indicates at least one contact from the list of recommended contacts transmitted to the user device that is to be included as a participant in the shared resource pool, and where the shared resource pool is augmented in response to ascertained completion of one or more objectives that must be completed to reach the finite resource cap. One or more user requests are received via the network from a plurality of users that include the at least one contact, where the one or more user requests initiate incorporating of the plurality of users in the shared resource pool. Respective authentication credentials of the plurality of users are authenticated by comparing the respective authentication credentials to stored user authentication credentials, and based thereon access to the shared resource pool is granted. A user records log of user contributions for completing the one or more objectives is maintained, and status data used to initiate display of a progress status indicator representing completion of the one or more objectives is updated. Once the finite resource cap is satisfied, one or more resources are distributed to user accounts of the plurality of users, where the one or more resources that are distributed to each of the user accounts are less than the shared resource pool.

Additionally, disclosed herein is a computer-implemented method that includes receiving and validating authentication credentials of a user by comparing the authentication credentials to stored authentication credentials. The method further includes generating and transmitting to a user device a list of recommended contacts for display, the list of recommended contacts being generated in response to stored user data associated with the stored authentication credentials. The method also includes receiving, via a network from the user device, a request to create a shared resource pool of resources that has a finite resource cap, the request indicating at least one contact from the list of recommended contacts transmitted to the user device that is to be included as a participant in the shared pool, wherein the shared resource pool is augmented in response to ascertained completion of one or more objectives that must be completed to reach the finite resource cap. In addition, the method includes receiving, via the network, one or more user requests from a plurality of users that include the at least one contact, the one or more user requests initiating incorporating of the plurality of users in the shared resource pool, and authenticating respective authentication credentials of the plurality of users by comparing the respective authentication credentials to stored user authentication credentials, and based thereon grant access to the shared resource pool. The method further includes maintaining a user records log of user contributions for completing the one or more objectives, updating status data used to initiate display of a progress status indicator representing completion of the one or more objectives, and distributing, once the finite resource cap is satisfied, one or more resources to user accounts of the plurality of users, the one or more resources that are distributed to each of the user accounts being less than the shared resource pool.

The features, functions, and advantages that have been discussed may be achieved independently in various embodiments of the present invention or may be combined in yet other embodiments, further details of which can be seen with reference to the following description and drawings.

### BRIEF DESCRIPTION OF THE SEVERAL VIEWS OF THE DRAWINGS

One or more aspects are particularly pointed out and distinctly claimed as examples in the claims at the conclusion of the specification. The foregoing as well as objects, features, and advantages of one or more aspects are apparent from the following detailed description taken in conjunction with the accompanying drawings in which:

FIG. 1 illustrates an enterprise system and environment thereof for maintaining privileged user resource access, in accordance with an embodiment of the present invention;

FIG. 2 is a diagram of an example graphical user interface associated with a shared pool of resources, in accordance with an embodiment of the present invention;

FIG. 3 is a diagram of an example graphical user interface associated with a shared pool of resources, in accordance with an embodiment of the present invention;

FIG. 4A is a diagram of an example graphical user interface associated with a contact, in accordance with an embodiment of the present invention;

FIG. 4B is a diagram of another example graphical user interface associated with a contact, in accordance with an embodiment of the present invention;

FIG. 5 is a diagram of an example graphical user interface associated with a plurality of recommended contacts and shared pools of resources, in accordance with an embodiment of the present invention;

FIG. 6A is a block diagram representing an example method, according to an embodiment of the present invention, of initiating privileged user access to a shared pool of resources;

FIG. 6B is a block diagram representing additional aspects of the example method of FIG. 6A, in accordance with an embodiment of the present invention;

FIG. 7A is a block diagram of an example method, in accordance with an embodiment of the present invention;

FIG. 7B is a block diagram representing additional aspects of the example method of FIG. 7A, in accordance with an embodiment of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout. Unless described or implied as exclusive alternatives, features throughout the drawings and descriptions should be taken as cumulative, such that features expressly associated with some particular embodiments can be combined with other embodiments. Unless defined otherwise, technical and scientific terms used herein have the same meaning as commonly understood to one of ordinary skill in the art to which the presently disclosed subject matter pertains.

The exemplary embodiments are provided so that this disclosure will be both thorough and complete, and will fully convey the scope of the invention and enable one of ordinary skill in the art to make, use, and practice the invention.

The terms “coupled,” “fixed,” “attached to,” “communicatively coupled to,” “operatively coupled to,” and the like refer to both (i) direct connecting, coupling, fixing, attaching, communicatively coupling; and (ii) indirect connecting coupling, fixing, attaching, communicatively coupling via one or more intermediate components or features, unless otherwise specified herein. “Communicatively coupled to” and “operatively coupled to” can refer to physically and/or electrically related components.

Embodiments of the present invention described herein, with reference to flowchart illustrations and/or block diagrams of methods or apparatuses (the term “apparatus” includes systems and computer program products), will be understood such that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a particular machine, such that the instructions, which execute via the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer readable memory produce an article of manufacture including instructions, which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions, which execute on the computer or other programmable apparatus, provide steps for implementing the functions/acts specified in the flowchart and/or block diagram block or blocks. Alternatively, computer program implemented steps or acts may be combined with operator or human implemented steps or acts in order to carry out an embodiment of the invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the herein described embodiments can be configured without departing from the scope and spirit of the invention. Therefore, it is to be understood that, within the scope of the included claims, the invention may be practiced other than as specifically described herein.

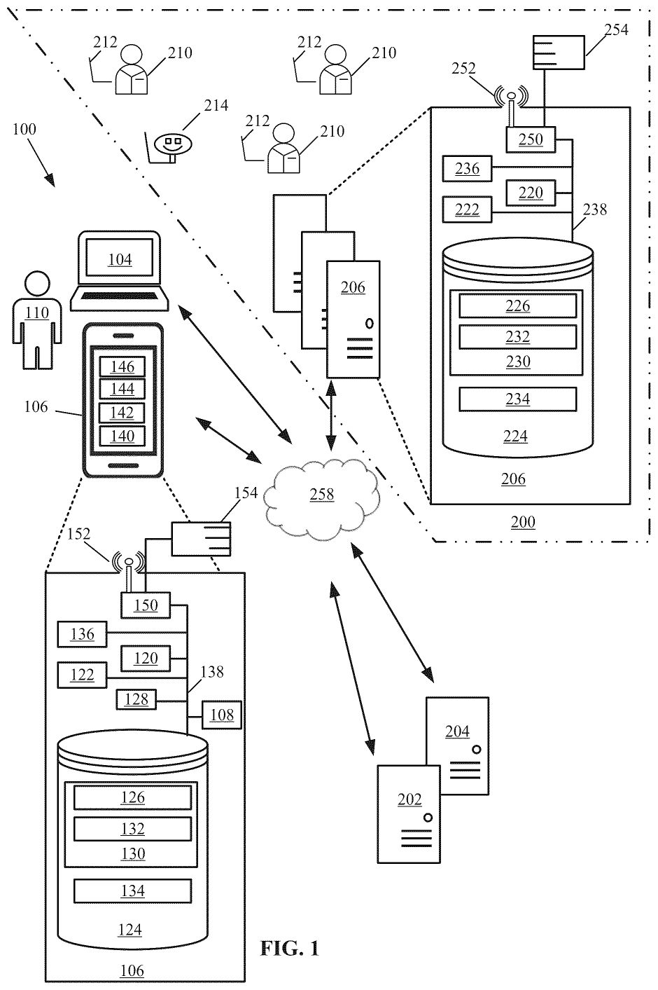

FIG. 1 illustrates a system 100 and environment thereof, according to at least one embodiment, by which a user 110 benefits through use of services and products of an enterprise system 200. The user 110 accesses services and products by use of one or more user devices, illustrated in separate examples as a computing device 104 and a mobile device 106, which may be, as non-limiting examples, a smart phone, a portable digital assistant (PDA), a pager, a mobile television, a gaming device, a laptop computer, a camera, a video recorder, an audio/video player, radio, a GPS device, or any combination of the aforementioned, or other portable device with processing and communication capabilities. In the illustrated example, the mobile device 106 is illustrated in FIG. 1 as having exemplary elements, the below descriptions of which apply as well to the computing device 104, which can be, as non-limiting examples, a desktop computer, a laptop computer, or other user-accessible computing device.

Furthermore, the user device, referring to either or both of the computing device 104 and the mobile device 106, may be or include a workstation, a server, or any other suitable device, including a set of servers, a cloud-based application or system, or any other suitable system, adapted to execute, for example any suitable operating system, including Linux, UNIX, Windows, macOS, iOS, Android and any other known operating system used on personal computers, central computing systems, phones, and other devices.

The user 110 can be an individual, a group, or any entity in possession of or having access to the user device, referring to either or both of the computing device 104 and mobile device 106, which may be personal or public items. Although the user 110 may be singly represented in some drawings, at least in some embodiments according to these descriptions the user 110 is one of many such that a market or community of users, consumers, customers, business entities, government entities, clubs, and groups of any size are all within the scope of these descriptions.

The user device, as illustrated with reference to the mobile device 106, includes components such as, at least one of each of a processing device 120, and a memory device 122 for processing use, such as random access memory (RAM), and read-only memory (ROM). The illustrated mobile device 106 further includes a storage device 124 including at least one of a non-transitory storage medium, such as a microdrive, for long-term, intermediate-term, and short-term storage of computer-readable instructions 126 for execution by the processing device 120. For example, the instructions 126 can include instructions for an operating system and various applications or programs 130, of which the application 132 is represented as a particular example. The storage device 124 can store various other data items 134, which can include, as non-limiting examples, cached data, user files such as those for pictures, audio and/or video recordings, files downloaded or received from other devices, and other data items preferred by the user or required or related to any or all of the applications or programs 130.

The memory device 122 is operatively coupled to the processing device 120. As used herein, memory includes any computer readable medium to store data, code, or other information. The memory device 122 may include volatile memory, such as volatile Random Access Memory (RAM) including a cache area for the temporary storage of data. The memory device 122 may also include non-volatile memory, which can be embedded and/or may be removable. The non-volatile memory can additionally or alternatively include an electrically erasable programmable read-only memory (EEPROM), flash memory or the like.

The memory device 122 and storage device 124 can store any of a number of applications which comprise computer-executable instructions and code executed by the processing device 120 to implement the functions of the mobile device 106 described herein. For example, the memory device 122 may include such applications as a conventional web browser application and/or a mobile P2P payment system client application. These applications also typically provide a graphical user interface (GUI) on the display 140 that allows the user 110 to communicate with the mobile device 106, and, for example a mobile banking system, and/or other devices or systems. In one embodiment, when the user 110 decides to enroll in a mobile banking program, the user 110 downloads or otherwise obtains the mobile banking system client application from a mobile banking system, for example enterprise system 200, or from a distinct application server. In other embodiments, the user 110 interacts with a mobile banking system via a web browser application in addition to, or instead of, the mobile P2P payment system client application.

The processing device 120, and other processors described herein, generally include circuitry for implementing communication and/or logic functions of the mobile device 106. For example, the processing device 120 may include a digital signal processor, a microprocessor, and various analog to digital converters, digital to analog converters, and/or other support circuits. Control and signal processing functions of the mobile device 106 are allocated between these devices according to their respective capabilities. The processing device 120 thus may also include the functionality to encode and interleave messages and data prior to modulation and transmission. The processing device 120 can additionally include an internal data modem. Further, the processing device 120 may include functionality to operate one or more software programs, which may be stored in the memory device 122, or in the storage device 124. For example, the processing device 120 may be capable of operating a connectivity program, such as a web browser application. The web browser application may then allow the mobile device 106 to transmit and receive web content, such as, for example, location-based content and/or other web page content, according to a Wireless Application Protocol (WAP), Hypertext Transfer Protocol (HTTP), and/or the like.

The memory device 122 and storage device 124 can each also store any of a number of pieces of information, and data, used by the user device and the applications and devices that facilitate functions of the user device, or are in communication with the user device, to implement the functions described herein and others not expressly described. For example, the storage device may include such data as user authentication information, etc.

The processing device 120, in various examples, can operatively perform calculations, can process instructions for execution, and can manipulate information. The processing device 120 can execute machine-executable instructions stored in the storage device 124 and/or memory device 122 to thereby perform methods and functions as described or implied herein, for example by one or more corresponding flow charts expressly provided or implied as would be understood by one of ordinary skill in the art to which the subject matters of these descriptions pertain. The processing device 120 can be or can include, as non-limiting examples, a central processing unit (CPU), a microprocessor, a graphics processing unit (GPU), a microcontroller, an application-specific integrated circuit (ASIC), a programmable logic device (PLD), a digital signal processor (DSP), a field programmable gate array (FPGA), a state machine, a controller, gated or transistor logic, discrete physical hardware components, and combinations thereof. In some embodiments, particular portions or steps of methods and functions described herein are performed in whole or in part by way of the processing device 120, while in other embodiments methods and functions described herein include cloud-based computing in whole or in part such that the processing device 120 facilitates local operations including, as non-limiting examples, communication, data transfer, and user inputs and outputs such as receiving commands from and providing displays to the user.

The mobile device 106, as illustrated, includes an input and output system 136, referring to, including, or operatively coupled with, user input devices and user output devices, which are operatively coupled to the processing device 120. The user output devices include a display 140 (e.g., a liquid crystal display or the like), which can be, as a non-limiting example, a touch screen of the mobile device 106, which serves both as an output device, by providing graphical and text indicia and presentations for viewing by one or more user 110, and as an input device, by providing virtual buttons, selectable options, a virtual keyboard, and other indicia that, when touched, control the mobile device 106 by user action. The user output devices include a speaker 144 or other audio device. The user input devices, which allow the mobile device 106 to receive data and actions such as button manipulations and touches from a user such as the user 110, may include any of a number of devices allowing the mobile device 106 to receive data from a user, such as a keypad, keyboard, touch-screen, touchpad, microphone 142, mouse, joystick, other pointer device, button, soft key, and/or other input device(s). The user interface may also include a camera 146, such as a digital camera.

Further non-limiting examples include, one or more of each, any, and all of a wireless or wired keyboard, a mouse, a touchpad, a button, a switch, a light, an LED, a buzzer, a bell, a printer and/or other user input devices and output devices for use by or communication with the user 110 in accessing, using, and controlling, in whole or in part, the user device, referring to either or both of the computing device 104 and a mobile device 106. Inputs by one or more user 110 can thus be made via voice, text or graphical indicia selections. For example, such inputs in some examples correspond to user-side actions and communications seeking services and products of the enterprise system 200, and at least some outputs in such examples correspond to data representing enterprise-side actions and communications in two-way communications between a user 110 and an enterprise system 200.

The mobile device 106 may also include a positioning device 108, which can be for example a global positioning system device (GPS) configured to be used by a positioning system to determine a location of the mobile device 106. For example, the positioning system device 108 may include a GPS transceiver. In some embodiments, the positioning system device 108 includes an antenna, transmitter, and receiver. For example, in one embodiment, triangulation of cellular signals may be used to identify the approximate location of the mobile device 106. In other embodiments, the positioning device 108 includes a proximity sensor or transmitter, such as an RFID tag, that can sense or be sensed by devices known to be located proximate a merchant or other location to determine that the consumer mobile device 106 is located proximate these known devices.

In the illustrated example, a system intraconnect 138, connects, for example electrically, the various described, illustrated, and implied components of the mobile device 106. The intraconnect 138, in various non-limiting examples, can include or represent, a system bus, a high-speed interface connecting the processing device 120 to the memory device 122, individual electrical connections among the components, and electrical conductive traces on a motherboard common to some or all of the above-described components of the user device. As discussed herein, the system intraconnect 138 may operatively couple various components with one another, or in other words, electrically connects those components, either directly or indirectly—by way of intermediate component(s)—with one another.

The user device, referring to either or both of the computing device 104 and the mobile device 106, with particular reference to the mobile device 106 for illustration purposes, includes a communication interface 150, by which the mobile device 106 communicates and conducts transactions with other devices and systems. The communication interface 150 may include digital signal processing circuitry and may provide two-way communications and data exchanges, for example wirelessly via wireless communication device 152, and for an additional or alternative example, via wired or docked communication by mechanical electrically conductive connector 154. Communications may be conducted via various modes or protocols, of which GSM voice calls, SMS, EMS, MMS messaging, TDMA, CDMA, PDC, WCDMA, CDMA2000, and GPRS, are all non-limiting and non-exclusive examples. Thus, communications can be conducted, for example, via the wireless communication device 152, which can be or include a radio-frequency transceiver, a Bluetooth device, Wi-Fi device, a Near-field communication device, and other transceivers. In addition, GPS (Global Positioning System) may be included for navigation and location-related data exchanges, ingoing and/or outgoing. Communications may also or alternatively be conducted via the connector 154 for wired connections such by USB, Ethernet, and other physically connected modes of data transfer.

The processing device 120 is configured to use the communication interface 150 as, for example, a network interface to communicate with one or more other devices on a network. In this regard, the communication interface 150 utilizes the wireless communication device 152 as an antenna operatively coupled to a transmitter and a receiver (together a “transceiver”) included with the communication interface 150. The processing device 120 is configured to provide signals to and receive signals from the transmitter and receiver, respectively. The signals may include signaling information in accordance with the air interface standard of the applicable cellular system of a wireless telephone network. In this regard, the mobile device 106 may be configured to operate with one or more air interface standards, communication protocols, modulation types, and access types. By way of illustration, the mobile device 106 may be configured to operate in accordance with any of a number of first, second, third, fourth, fifth-generation communication protocols and/or the like. For example, the mobile device 106 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols such as Long-Term Evolution (LTE), fifth-generation (5G) wireless communication protocols, Bluetooth Low Energy (BLE) communication protocols such as Bluetooth 5.0, ultra-wideband (UWB) communication protocols, and/or the like. The mobile device 106 may also be configured to operate in accordance with non-cellular communication mechanisms, such as via a wireless local area network (WLAN) or other communication/data networks.

The communication interface 150 may also include a payment network interface. The payment network interface may include software, such as encryption software, and hardware, such as a modem, for communicating information to and/or from one or more devices on a network. For example, the mobile device 106 may be configured so that it can be used as a credit or debit card by, for example, wirelessly communicating account numbers or other authentication information to a terminal of the network. Such communication could be performed via transmission over a wireless communication protocol such as the Near-field communication protocol.

The mobile device 106 further includes a power source 128, such as a battery, for powering various circuits and other devices that are used to operate the mobile device 106. Embodiments of the mobile device 106 may also include a clock or other timer configured to determine and, in some cases, communicate actual or relative time to the processing device 120 or one or more other devices. For further example, the clock may facilitate timestamping transmissions, receptions, and other data for security, authentication, logging, polling, data expiry, and forensic purposes.

System 100 as illustrated diagrammatically represents at least one example of a possible implementation, where alternatives, additions, and modifications are possible for performing some or all of the described methods, operations and functions. Although shown separately, in some embodiments, two or more systems, servers, or illustrated components may utilized. In some implementations, the functions of one or more systems, servers, or illustrated components may be provided by a single system or server. In some embodiments, the functions of one illustrated system or server may be provided by multiple systems, servers, or computing devices, including those physically located at a central facility, those logically local, and those located as remote with respect to each other.

The enterprise system 200 can offer any number or type of services and products to one or more users 110. In some examples, an enterprise system 200 offers products. In some examples, an enterprise system 200 offers services. Use of “service(s)” or “product(s)” thus relates to either or both in these descriptions. With regard, for example, to online information and financial services, “service” and “product” are sometimes termed interchangeably. In non-limiting examples, services and products include retail services and products, information services and products, custom services and products, predefined or pre-offered services and products, consulting services and products, advising services and products, forecasting services and products, internet products and services, social media, and financial services and products, which may include, in non-limiting examples, services and products relating to banking, checking, savings, investments, credit cards, automatic-teller machines, debit cards, loans, mortgages, personal accounts, business accounts, account management, credit reporting, credit requests, and credit scores.

To provide access to, or information regarding, some or all the services and products of the enterprise system 200, automated assistance may be provided by the enterprise system 200. For example, automated access to user accounts and replies to inquiries may be provided by enterprise-side automated voice, text, and graphical display communications and interactions. In at least some examples, any number of human agents 210, can be employed, utilized, authorized or referred by the enterprise system 200. Such human agents 210 can be, as non-limiting examples, point of sale or point of service (POS) representatives, online customer service assistants available to users 110, advisors, managers, sales team members, and referral agents ready to route user requests and communications to preferred or particular other agents, human or virtual.

Human agents 210 may utilize agent devices 212 to serve users in their interactions to communicate and take action. The agent devices 212 can be, as non-limiting examples, computing devices, kiosks, terminals, smart devices such as phones, and devices and tools at customer service counters and windows at POS locations. In at least one example, the diagrammatic representation of the components of the mobile device 106 in FIG. 1 applies as well to one or both of the computing device 104 and the agent devices 212.

Agent devices 212 individually or collectively include input devices and output devices, including, as non-limiting examples, a touch screen, which serves both as an output device by providing graphical and text indicia and presentations for viewing by one or more agent 210, and as an input device by providing virtual buttons, selectable options, a virtual keyboard, and other indicia that, when touched or activated, control or prompt the agent device 212 by action of the attendant agent 210. Further non-limiting examples include, one or more of each, any, and all of a keyboard, a mouse, a touchpad, a joystick, a button, a switch, a light, an LED, a microphone serving as input device for example for voice input by a human agent 210, a speaker serving as an output device, a camera serving as an input device, a buzzer, a bell, a printer and/or other user input devices and output devices for use by or communication with a human agent 210 in accessing, using, and controlling, in whole or in part, the agent device 212.

Inputs by one or more human agents 210 can thus be made via voice, text or graphical indicia selections. For example, some inputs received by an agent device 212 in some examples correspond to, control, or prompt enterprise-side actions and communications offering services and products of the enterprise system 200, information thereof, or access thereto. At least some outputs by an agent device 212 in some examples correspond to, or are prompted by, user-side actions and communications in two-way communications between a user 110 and an enterprise-side human agent 210.

From a user perspective experience, an interaction in some examples within the scope of these descriptions begins with direct or first access to one or more human agents 210 in person, by phone, or online for example via a chat session or website function or feature. In other examples, a user is first assisted by a virtual agent 214 of the enterprise system 200, which may satisfy user requests or prompts by voice, text, or online functions, and may refer users to one or more human agents 210 once preliminary determinations or conditions are made or met.

A computing system 206 of the enterprise system 200 may include components such as, at least one of each of a processing device 220, and a memory device 222 for processing use, such as random access memory (RAM), and read-only memory (ROM). The illustrated computing system 206 further includes a storage device 224 including at least one non-transitory storage medium, such as a microdrive, for long-term, intermediate-term, and short-term storage of computer-readable instructions 226 for execution by the processing device 220. For example, the instructions 226 can include instructions for an operating system and various applications or programs 230, of which the application 232 is represented as a particular example. The storage device 224 can store various other data 234, which can include, as non-limiting examples, cached data, and files such as those for user accounts, user profiles, account balances, and transaction histories, files downloaded or received from other devices, and other data items preferred by the user or required or related to any or all of the applications or programs 230.

The computing system 206, in the illustrated example, includes an input/output system 236, referring to, including, or operatively coupled with input devices and output devices such as, in a non-limiting example, agent devices 212, which have both input and output capabilities.

In the illustrated example, a system intraconnect 238 electrically connects the various above-described components of the computing system 206. In some cases, the intraconnect 238 operatively couples components to one another, which indicates that the components may be directly or indirectly connected, such as by way of one or more intermediate components. The intraconnect 238, in various non-limiting examples, can include or represent, a system bus, a high-speed interface connecting the processing device 220 to the memory device 222, individual electrical connections among the components, and electrical conductive traces on a motherboard common to some or all of the above-described components of the user device.

The computing system 206, in the illustrated example, includes a communication interface 250, by which the computing system 206 communicates and conducts transactions with other devices and systems. The communication interface 250 may include digital signal processing circuitry and may provide two-way communications and data exchanges, for example wirelessly via wireless device 252, and for an additional or alternative example, via wired or docked communication by mechanical electrically conductive connector 254. Communications may be conducted via various modes or protocols, of which GSM voice calls, SMS, EMS, MMS messaging, TDMA, CDMA, PDC, WCDMA, CDMA2000, and GPRS, are all non-limiting and non-exclusive examples. Thus, communications can be conducted, for example, via the wireless device 252, which can be or include a radio-frequency transceiver, a Bluetooth device, Wi-Fi device, Near-field communication device, and other transceivers. In addition, GPS (Global Positioning System) may be included for navigation and location-related data exchanges, ingoing and/or outgoing. Communications may also or alternatively be conducted via the connector 254 for wired connections such as by USB, Ethernet, and other physically connected modes of data transfer.

The processing device 220, in various examples, can operatively perform calculations, can process instructions for execution, and can manipulate information. The processing device 220 can execute machine-executable instructions stored in the storage device 224 and/or memory device 222 to thereby perform methods and functions as described or implied herein, for example by one or more corresponding flow charts expressly provided or implied as would be understood by one of ordinary skill in the art to which the subjects matters of these descriptions pertain. The processing device 220 can be or can include, as non-limiting examples, a central processing unit (CPU), a microprocessor, a graphics processing unit (GPU), a microcontroller, an application-specific integrated circuit (ASIC), a programmable logic device (PLD), a digital signal processor (DSP), a field programmable gate array (FPGA), a state machine, a controller, gated or transistor logic, discrete physical hardware components, and combinations thereof.

Furthermore, the computing system 206, may be or include a workstation, a server, or any other suitable device, including a set of servers, a cloud-based application or system, or any other suitable system, adapted to execute, for example any suitable operating system, including Linux, UNIX, Windows, macOS, IOS, Android, and any known other operating system used on personal computer, central computing systems, phones, and other devices.

The user devices, referring to either or both of the computing device 104 and mobile device 106, the agent devices 212, and the enterprise computing system 206, which may be one or any number centrally located or distributed, are in communication through one or more networks, referenced as network 258 in FIG. 1.

Disclosed herein are systems and methods for authenticating users in order to grant access to a digital platform in which graphical user interfaces are generated to display information to help users collaborate together and pool resources (e.g., money, points, cryptocurrency, etc.) towards a common goal. The computing system 206 can be configured to receive, from a user device such as mobile device 106 or computing device 104, a request to initiate a shared pool of resources for a desired goal or objective. An example of a shared pool of resources can include an online aggregation of a group of resources shared by at least two users. The types of resources can vary, and in some embodiments the resources can include money, stocks, exchange-traded funds (ETFs), or cryptocurrency. Digital money associated with an online game or online world can also be a resource. In one particular embodiment, the online game may involve achieving one or more objectives by collaborating together on projects, acknowledging or providing feedback to other users of the online game, completing financial goals, etc. Shared resource pools can be limited to one resource type, or they can be a combination of many resource types shared between the two or more users. Users 110 can utilize their user devices (e.g. the computing device 104, the mobile device 106, etc.) to connect to the enterprise system 200 or computing system 206 and interact with other users to contribute resources to the shared resource pool and further shared user goals. To contribute resources to the shared resource pool, users can complete one or more objectives via interaction with the user device such as computing device 104 or mobile device 106, completion of those objectives in turn add resources to the shared resource pool and further progress towards achieving the user's goals. Objectives can vary depending upon the needs of the enterprise system and may include, according to various embodiments, depositing money or cryptocurrency into a shared user pool, accomplishing tasks, obtaining financial objectives (e.g., setting up direct deposit, saving a certain amount of money, limiting certain categories of expenses, etc.). Objectives can also include completing online quests or mini-games associated with earning virtual or currency awards associated with a monetary value. For example, when a user completes certain quests, tasks, objectives, mini-games, etc., the user may collect points that can be exchanged for actual currency. That actual currency may then be deposited as a contribution towards the finite resource cap (e.g., the total amount of money sought to be set aside for a specific purpose).

Network 258 provides wireless or wired communications among the components of the system 100 and the environment thereof, including other devices local or remote to those illustrated, such as additional mobile devices, servers, and other devices communicatively coupled to network 258, including those not illustrated in FIG. 1. The network 258 is singly depicted for illustrative convenience, but may include more than one network without departing from the scope of these descriptions. In some embodiments, the network 258 may be or provide one or more cloud-based services or operations. The network 258 may be or include an enterprise or secured network, or may be implemented, at least in part, through one or more connections to the Internet. A portion of the network 258 may be a virtual private network (VPN) or an Intranet. The network 258 can include wired and wireless links, including, as non-limiting examples, 802.11a/b/g/n/ac, 802.20, WiMax, LTE, and/or any other wireless link. The network 258 may include any internal or external network, networks, sub-network, and combinations of such operable to implement communications between various computing components within and beyond the illustrated environment 100. The network 258 may communicate, for example, Internet Protocol (IP) packets, Frame Relay frames, Asynchronous Transfer Mode (ATM) cells, voice, video, data, and other suitable information between network addresses. The network 258 may also include one or more local area networks (LANs), radio access networks (RANs), metropolitan area networks (MANs), wide area networks (WANs), all or a portion of the internet and/or any other communication system or systems at one or more locations.

In an embodiment of the invention, user devices connect to the network 258 to exchange information to facilitate interactions between the user 110 and the computing system 206. The network 258 may transmit data regarding user interactions to the appropriate destination (i.e. the enterprise system 200, the computing system 206, agent devices 212, etc.). The network 258 may use wired or wireless connections to facilitate communication channels between the enterprise system 200 and user device(s) (e.g. the computing device 104, the mobile device 106, etc.).

Two external systems 202 and 204 are expressly illustrated in FIG. 1, representing any number and variety of data sources, users, consumers, customers, business entities, banking systems, government entities, clubs, and groups of any size are all within the scope of the descriptions. In at least one example, the external systems 202 and 204 represent automatic teller machines (ATMs) utilized by the enterprise system 200 in serving users 110. In another example, the external systems 202 and 204 represent payment clearinghouse or payment rail systems for processing payment transactions, and in another example, the external systems 202 and 204 represent third party systems such as merchant systems configured to interact with the mobile device 106 during transactions and also configured to interact with the enterprise system 200 in back-end transactions clearing processes.

In certain embodiments, one or more of the systems such as the mobile device 106, the enterprise system 200, and/or the external systems 202 and 204 are, include, or utilize virtual resources. In some cases, such virtual resources are considered cloud resources or virtual machines. Such virtual resources may be available for shared use among multiple distinct resource consumers and in certain implementations, virtual resources do not necessarily correspond to one or more specific pieces of hardware, but rather to a collection of pieces of hardware operatively coupled within a cloud computing configuration so that the resources may be shared as needed.

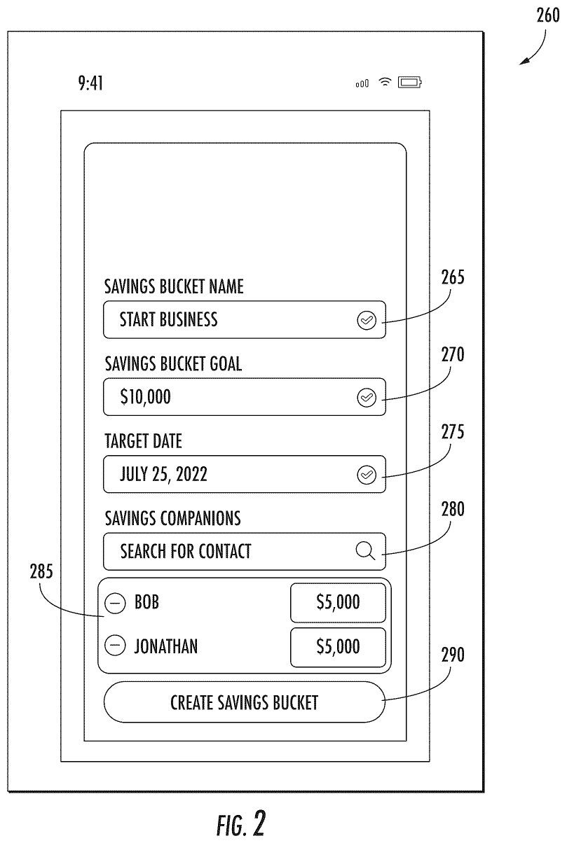

FIG. 2 is a diagram of a graphical user interface 260 associated with a shared pool of resources. The graphical user interface (GUI) 260 displays a series of prompts for the user to indicate goals relating to the shared resource pool. For instance, the non-limiting example of the shared resource pool depicted by GUI 260 is as indicated by the pool label 265 is to start a business. In this example, the idea is to pool resources from other users to help the user achieve their goal of saving $10,000 to start a business. Any number of examples may be used to pool resources for a common goal including, but not limited to, saving for tuition, saving for a medical operation, saving for a trip, saving for a wedding, saving for an event, saving for a charity group, etc. The pool label 265 allows for the user(s) to manually type or select from a preselected list of options to create an identifying word or phrase to identify a purpose for their collaborative resource pool(s). In an embodiment, pool labels 265 represent a “savings bucket name” and are limited to unique identifying words or phrases to name or otherwise identify the collaborative resource pool, such as a description of the resource(s) that the users are saving or an intended purpose for which the users are saving their resources. In another embodiment, the pool labels 265 are not unique and are assigned automatically by the system to reflect the resource type(s) that are to be collected and the savings goal purpose. In addition, an amount that is to be collected in order to achieve the savings goal purpose may be identified by the finite resource cap 270 or “savings bucket goal”. The finite resource cap 270 indicates the upper ceiling of the resources of the shared resource pool such that the savings goal would be achieved once the total amount identified by the finite resource cap 270 is collected. The finite resource cap 270 can indicate a monetary value or a quantity of a given resource that the users intend to reach. For resources that involve cryptocurrency, stock, or some other volatile digital resource with variable monetary value, the system will prompt a user to indicate either a monetary value or a quantity, the assumed monetary value of said quantity being based on variability within the market at the time of the request. For example, a group of users with a shared goal may choose to create a shared resource pool combining held publicly traded stocks. Due to market variability, the value of a singular stock will change from day to day. Therefore, the system will prompt the users to select either a monetary target (i.e. $10,000, etc.) or an amount of held shares (i.e. 30 shares, etc.) to ensure that all users clearly understand the shared savings goal they are contributing to. In an embodiment, market variability information used by the system to update the progress of the shared resource pool may come from data stored to an enterprise database (e.g. the computing system 206, etc.) or indications from one or more users.

In some embodiments, the user may select a target date 275 for completing the goal identified by the pool label 265 in the amount identified by the finite resource cap 270. The target date 275 indicates a completion date for pooling sufficient resources to satisfy the finite resource cap 270. In an embodiment of the invention, users can indicate if the target date 275 is a final deadline, at which point no more contributions towards completing the goal can be pooled together, or if it is merely a suggested deadline for prioritizing the completion of the total amount of resources defined by the finite resource cap 270. Indication of a target date 275 can be optional, or it can be required according to various embodiments. The GUI 260 may also depict a search bar 280 that allows for a user input terms (e.g., a name, an email address, a phone number, a social media handle, etc.) in order to conduct a search of stored contacts that are stored to a database. In one embodiment, the search is used to generate recommended contacts. As used herein, the term recommended contact may reference a contact that the system recommends to the user. The contact may be recommend individuals based on information known about the user. For instance, the system may recommend contacts that the user may know or otherwise be acquainted with based on searches that the user performs via the search bar 280. For example, the user may type in the name Bob Smith into the search bar 280 and the system may generate and display recommended contacts (e.g., using identifiable user names or social media handles) that might correspond to the Bob Smith that the user typed into the search bar 280. Recommended contacts of a user can be an element of the user data stored in an enterprise database (i.e. the computing system 206, etc.) or stored locally within a user device (e.g. the mobile device 106 or the computing device 104). For example, the user data may be used to identify individuals named Bob Smith within a predefined radius of the user's address as identified by the user data. In another example, the user data may be linked to a social media account of the user and the names of connections made through the social media account may be used to identify recommended contacts. Various other connections and data correlations may be used in order to recommend certain contacts to the user. In the embodiment wherein the user accesses the system using a mobile device, the recommended contacts can be populated by accessing, with permission, identifying information (e.g., phone number, address, name, etc.) of the user contacts stored on the user mobile device.

The user can indicate one or more contacts that the user would want to participate in the shared resource pool by searching, via the search bar 280, and selecting specific recommended contacts in order to initiate a shared resource pool. If a user initiating setup of the shared resource pool does not indicate a contact to be included in the shared resource pool, the system can trigger a dialogue box reminding the user to make a selection of at least one contact. Should the user ignore or otherwise not interact with the dialogue box within a predefined period of time (e.g., due to the dialog box timing out), the system can automatically choose a contact to join the shared pool of resources. This automated selection can be based on known user relationships (such as spouses, parents, siblings, or other relationships) as identified by the user data or it can be based on predicted based on perceived user relationships recorded in a relational database (e.g., based on a likelihood of probability that the user would know the contact). For example, the user data may indicate a current address of the user and the system may automatically select a contact based on the contact having an address near or the same as a user (e.g., possibly roommates, neighbors, etc.). In some embodiments, the user's age, gender, etc. may be used to make the connection. In some embodiments, the rules used to make the automated selection may be based on security standards to ensure that the environment for pooling resources is a safe space for all participants (e.g., to ensure that a participant that is a minor or underage is not connected with an adult). In some embodiments, the relational database will record user-to-user interactions and create perceived user relationships according to the frequency of user-to-user interactions. In an embodiment, the relational database will populate a suggested contacts list (which identifies individuals likely to be connected to the user based on perceived and/or predicted relationships), which is separate from the recommended contacts list (which are populated in response to a search for a potential contact).

A distribution unit 285 displays the recommended contacts associated with the request and the proportional distribution of contributions sought by the user for the contacts to contribute to the shared resource pool. For example, the distribution unit 285 indicates that “Bob” is to contribute $5,000 and “Jonathan” $5,000 so that the total amount of $10,000 that is being sought can be completed. The distribution unit 285 indicates the proportional responsibility of each of the users that would need to be contributed to the shared resource pool in order to reach the total amount of resources sought as defined by the finite resource cap 270. Users can choose to indicate an equal proportional distribution of contributions, wherein each user is expected to contribute the same amount to a shared resource pool, or users can choose to delegate a non-equal distribution of contributions in other embodiments. For example, the user could indicate that one user is to contribute $1,000, another user is to contribute $4,000, and a third user is to contribute $5,000 in order to reach the $10,000 total amount being sought. Similar to the finite resource cap 270, the proportional distribution of contributions can be indicated as either a monetary value or a quantity of resources. In some embodiments of the invention, the distribution unit 285 may impose a limitation on the amount of users associated with a shared resource pool. In that embodiment, when the user transmits a request to initiate a shared resource pool with a finite resource cap, the backend system will perform a check to ensure that the number of users indicated in the distribution unit 285 is not greater than the number of allowed users.

The initiation button 290 initiates the process to create a shared resource pool with a finite resource cap among a plurality of users. When the user interacts with the initiation button 290, a request to initiate a shared resource pool with a finite resource cap will be transmitted from the user device (e.g. the computing device 104 or the mobile device 106 of FIG. 1) to the backend computing system of the enterprise associated with the digital platform (e.g., computing system 206 of the enterprise system 200 of FIG. 1). After receiving the transmitted request, the backend computing system of the enterprise will verify that each of the required fields are complete (e.g., in an embodiment, the finite resource cap 270 has been selected, and at least one contact is indicated by the distribution unit 285). If any of the required fields are not completed, the computing system will transmit an error message to the user device to indicate there are missing required fields and suggesting values that the user may select in order to complete the initiation process of the shared resource pool. In some embodiments of the invention, the system will have a maximum amount of shared resource pools for which one user can be a member (e.g. indicated as a participant in the distribution unit 285). In that embodiment, the backend system will perform a check ensuring that each user indicated in the distribution unit 285 would not exceed their allotted amount of shared resource pools if they were to participate in the resource pool currently being requested. Should the computing system confirm that all required fields are present and completed and that all requirements are fulfilled, the request to initiate a shared pool of resources with a finite resource cap will be granted, and the user shall be notified that the shared resource pool has been created. According to various embodiments, notification can come in the form of a push notification, a short message service (SMS), or an email. In some embodiments, notifications are also sent to the contacts identified by the distribution unit 285 to alert the contacts that they have been included in a shared resource pool.

Once the shared resource pool has been created, the users identified by the distribution unit 285 may make contributions towards the shared resource pool. In some embodiments, the shared resource pool may be made public and contributions may be made by individuals who are not contacts or in any way associated with the user. In other embodiments, the user can make the shared resource pool private to only those contacts listed by the distribution unit 285. In some embodiments, the user may include themselves as a contributor in the shared resource pool. As contributions are made towards the shared resource pool, progress towards the finite resource cap is being monitored by the backend system. Should the computing system determine that the finite resource cap has been reached and that the total amount of resources sought by the user has been satisfied, the computing system will then distribute the resources. In some embodiments, the resources are distributed evenly to each of the user accounts of the participants associated with the shared resource pool. In other embodiments, such as in a public shared resource pool, only those identified by the distribution unit 285 will receive resources. For example, if the objective was to earn $10,000 for five friends to travel together to New York City, the resources of the shared resource pool may be distributed in accordance with the preselected amounts identified by the user during setup of the shared resource pool (e.g., in equal distribution amounts to each person identified by the distribution unit 285, in unequal distribution amounts, etc.). Resources are distributed to each of the accounts (e.g., bank account, user profile, etc.) of the users associated with the finite resource pool and according to the values indicated in the distribution unit 285. In some embodiments, distribution will be triggered once all users associated with the shared resource pool have completed their proportional share of the contributions. Alternatively, in another embodiment, distribution will be triggered by the combination of all user contributions being greater than or equal to the finite resource cap. In one example, should one user contribute more than their proportional distribution as indicated in the distribution unit 285, the user resources can be distributed in a manner inconsistent with the proportions in the distribution unit 285 depending upon the distribution criteria selected by the user upon setup of the shared resource pool. In one embodiment of the invention, the computing system automatically distributes the resources to the plurality of users indicated in the distribution unit 285 on the target date 275, regardless of whether the finite resource cap 270 has been reached.

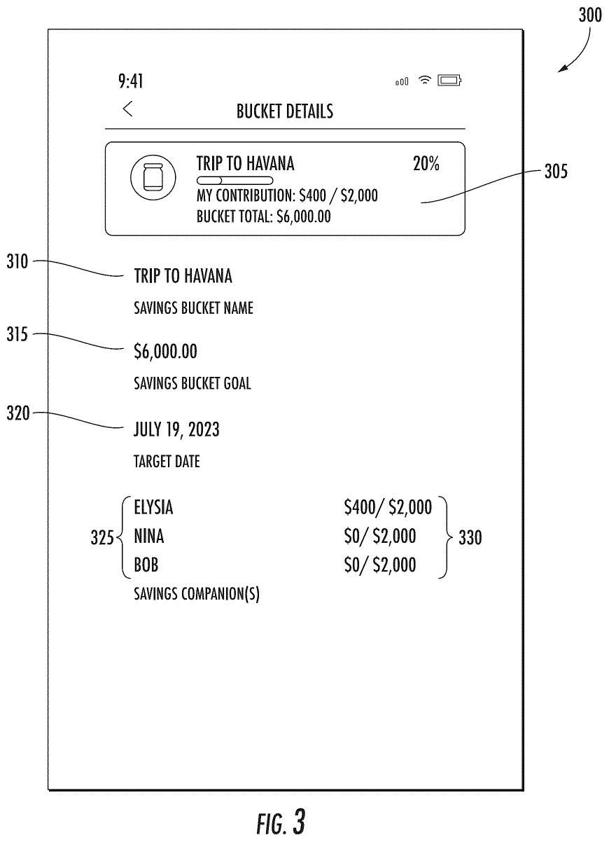

FIG. 3 is a diagram of a graphical user interface 300 associated with a shared pool of resources. The GUI 300 displays a progressive screen that follows completion of the setup process used to create a shared pool of resources with a finite resource cap. A progress status indicator 305 displays a percentage of completion relative to the total amount of one or more objectives necessary to satisfy the finite resource cap. The progress status indicator may include a label naming the purpose associated with the shared pool of resources (e.g., the same label of the shared pool of resources as the label 310) as well as an indication of the user's personal contributions to the finite resource cap. The progress status indicator is a dynamic indicator that updates with new information in real time as the computing system receives new information related to user actions from contributions of users. When the computing system receives an indication from the user records log that a user has wholly or partially completed one or more objectives associated with the completion of the finite resource cap, the computing system will transmit an update to the progress status indicator. A label 310 displays the user-indicated name of the shared resource pool. The finite resource cap indicator 315 displays the total amount of the “savings bucket goal”, which is representative of the finite cap that is applicable to the total amount of resources to be collected according to the indication made during setup of the shared resource pool using the finite resource cap 270 of FIG. 2. The target date label 320 indicates a target date of completion of the total amount of resources identified by the finite resource cap. A list 325 of the recommended contacts contributing to the shared resource pool is displayed with each of their respective user contribution amounts 330 listed alongside each name. In one embodiment, users who have already completed their respective portion of the total amount identified by the finite resource cap may optionally contribute additional resources that would be credited towards completion of the total amount of resources collected in order to advance the goals and assist their fellow users.

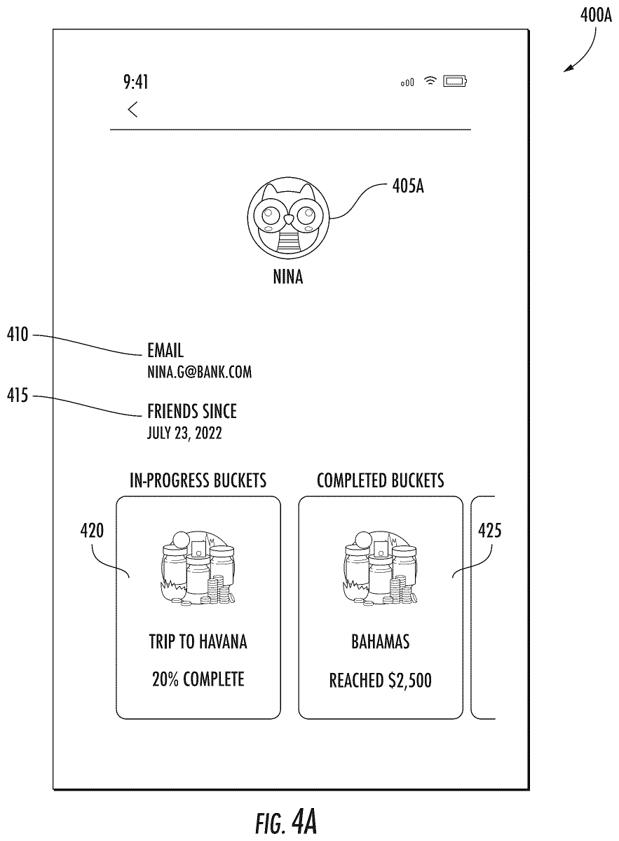

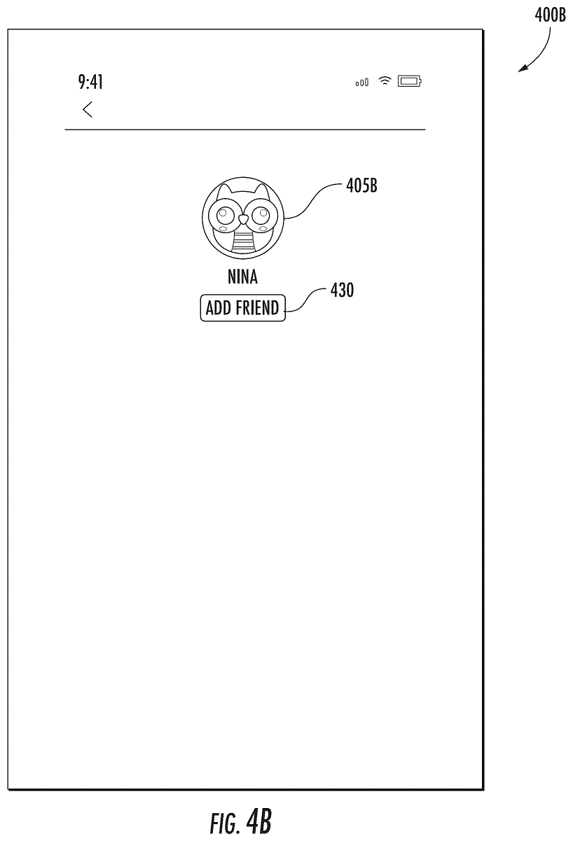

FIG. 4A is a diagram of an example graphical user interface (GUI) 400A associated with an existing contact with whom the user has previously connected through the application, in accordance with an embodiment of the present invention. In some embodiments, only certain portions of the GUI 400 will be displayed until an authentication process has been completed by the user. The contact avatar 405A is a graphical representation associated with the existing contact. In an embodiment, users may upload images or graphics to the computing system, those images may then be displayed as the user's contact avatar 405A. In another embodiment, the user is limited to a curated selection of user avatars to represent their contact avatar 405A. The contact information 410 displays known contact information of the user. Non-limiting examples of this contact information 410 may include email, phone number, name, address, etc. In some embodiments, users may choose to hide certain aspects of their contact information. For example, a user establishing a public-facing shared resource pool may not want to share their home address publicly on the Internet. This user would be able to modify the settings to hide their address, along with other identifying information that they do not feel comfortable publicly sharing. The contact indicator 415 indicates when the two users became contacts/connections/friends. In the illustrated embodiment of the invention, a user is able to see both completed buckets (i.e., resource pools) and in-progress buckets (i.e., resource pools) in which their contact/friend participates. The in-progress resource pool(s) 420 represent resource pools the contact is currently participating in that have not yet completed. A user viewing a contact's profile may be able to view details about the in-progress resource pool 420 by interacting with the user device to display of a progressive screen (e.g. the progressive screen of GUI 300). Users may also be able to view the completed resource pool(s) 425 associated with a recommended contact. A user viewing an existing contact's or a recommended contact's profile may be able to view the completed resource pool 425 by interacting with the user device, which then displays, via a user interface, a progressive screen (e.g. the progressive screen of GUI 300). In some embodiments, the system will not have relevant data to populate the in-progress resource pool(s) 420 or the completed resource pool(s) 425 (e.g. a user has only ever participated in private shared resource pools, a user has not participated in any shared resource pools, etc.), and those sections may appear blank or may not appear at all. Users are able to remove the contact connection via user input of the user device, which may alter the GUI display in accordance with the former contact's privacy settings.

FIG. 4B is a diagram of another example graphical user interface 400B associated with a contact, in accordance with an embodiment of the present invention. In the illustrated embodiment of the invention, the user is able to view a contact avatar 405B and a user input 430 to connect with another user/friend/contact with which they are not yet connected. Similar to the contact avatar 405A, the contact avatar 405B may be a visual representation of the user. In one embodiment of the invention, the contact avatar 405B will not be visible to users that are not yet connected via the contact system. The user input 430, once interacted with by a user via one or more user inputs, will transmit a request to create a contact relationship between two users. The request to create a contact relationship may be transmitted via a network to a system (e.g. the computing system 206 of FIG. 2, etc.). A user may be able to see more or less data (e.g. name, email address, complete and in-progress resource pools, etc.) associated with another user who is not yet a contact, depending on the privacy settings of the other user who is not yet a contact. In one embodiment, the act of adding a user as a contact may be one way of completing an objective of the objective(s) to be completed to in order to earn resources to help reach the finite resource cap.

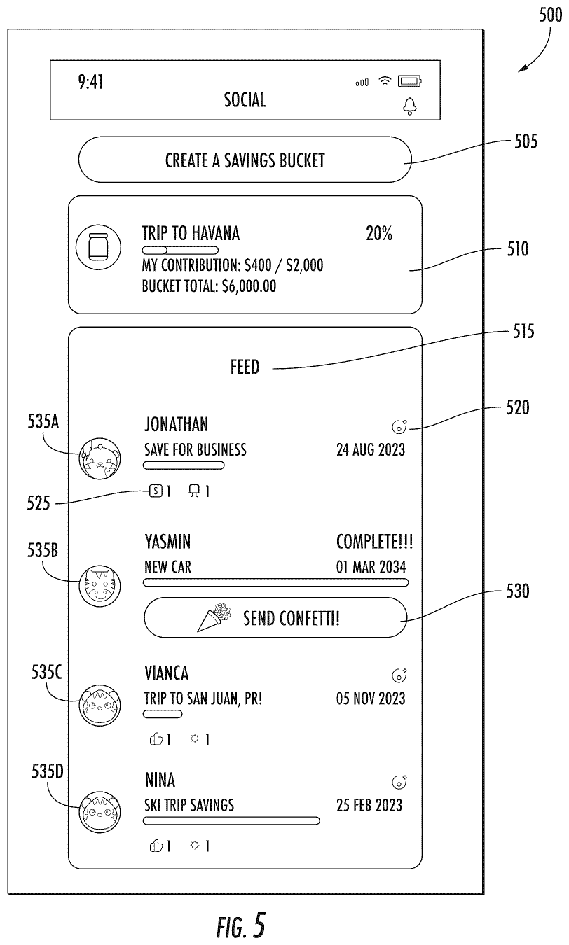

FIG. 5 is a diagram of a graphical user interface 500 associated with a user initiating display of a plurality of recommended contacts and shared pools of resources. The GUI 500 displays a social view of the application. The user input 505, in some embodiments, initiates the display of GUI 260 of FIG. 2, which enables a user to submit a request to create a shared pool of resources. A user, through user interactions, can interact with the user input 505 to begin the process to initiate a request to create a shared resource pool. The shared pool widget 510 displays a short summary of all in-progress shared resource pools with which a user account is associated. In the illustrated embodiment, a singular shared resource pool is shown. In another embodiment, the shared pool widget 510 may display multiple shared resource pools, should a user be a participant in multiple shared resource pools, or it may display no shared resource pools, should a user not be a participant in any shared resource pools at the time of display. The user can interact with the shared pool widget 510 via a user input, which, in some embodiments, may initiate the display of GUI 300 of FIG. 3; that GUI being associated with a user initiating display of a shared pool of resources. A user's social feed 515 displays recent user activity of a plurality of recommended contacts. The user social feed 515 is customized to only display contact actions the user has privilege to view via a contact connection. Contact actions represented in the user social feed 515 are populated via a user contributions log maintained by the enterprise system (e.g. the computing system 206 or the enterprise system 200 of FIG. 2, etc.) or the user device (e.g. the computing device 104 or the mobile device 106 of FIG. 2, etc.) for each individual contact's contribution to the one or more shared resource pools with which the contact(s) are associated. A reaction button 520 is provided to allow user social interactions via emoticon reactions 525 to user actions. One or more emoticon reactions 525 appear under the user activity when a recommended contact uses the reaction button 520. Users can interact with a user input 530 to send messages of encouragement to recommended contacts that have completed one or more goals satisfying the finite resource cap.

In an embodiment of the invention, users may make social posts, akin to a journal or diary, logging their personal experiences with completing goals and saving resources within the shared pool. These posts may be linked or associated with the specific shared resource pool about which a user is reflecting. They may inherit the privacy settings associated with the relevant shared resource pool, or they may have their own privacy settings. In an example, if Bob and Sally are saving for a honeymoon in a publicly viewable shared resource pool, and Bob receives a large bonus at work, Bob can create a private post associated with his public shared resource pool to reflect on how his bonus aided him in achieving his goals without sharing that information publicly. Should a user choose to make a post publicly available, the post could be used as contact action data to populate the social feed 515. In some embodiments, to further facilitate social interaction within the system, users may be able to comment on one another's posts to leave messages of encouragement, tips, or create relationships with like-minded users.

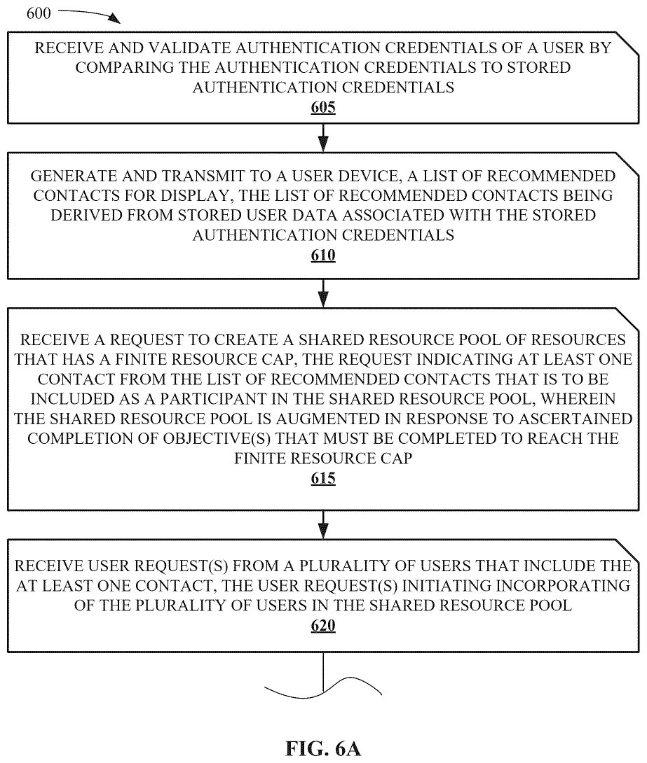

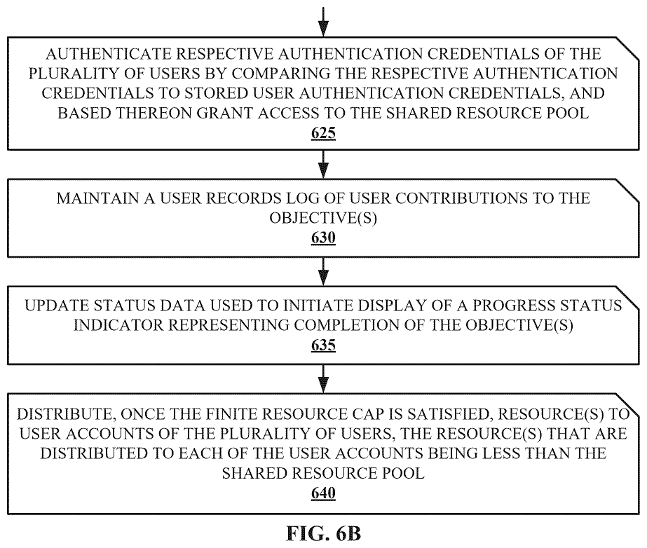

FIGS. 6A and 6B are block diagrams of an example method 600 for initiating privileged user access to a shared pool of resources. At block 605, the system receives and validates authentication credentials of a user by comparing the transmitted authentication credentials to stored authentication credentials. In an embodiment, the authentication process can be single-factor authentication of a username and password. In another embodiment, the authentication process can be multi-factor, including a username and password and a known trait of the user, such as a security question or PIN. In another embodiment, the authentication process can be biometric. Should the system fail to authenticate the authentication credentials of a user, the method may be terminated, and a message may be sent to the user via the network informing them of the failed authentication process.

At block 610, the system generates and transmits to a user device a list of recommended contacts for display, the list of recommended contacts being derived from stored user data associated with the stored authentication credentials. In the embodiment in which the user accesses the system via a user device, the recommended contacts list can be populated through access to the contacts stored on the user device via a request to access contacts. The recommended contacts list can also be populated through known contacts, such as other users that the authenticated user has interacted with in the past. Users can add and remove contacts from their contacts list. To interact with contacts who do not have an account within the system, the user can send a request to the contact to create an account. This request can be transmitted to the contact in the form of an SMS message, an email, or physical mail.

At block 615, the system receives, via a network and from the user device, a request to create a shared resource pool of resources that has a finite resource cap, the request indicating at least one contact, from the list of recommended contacts that was transmitted to the user device, that is to be included as a participant in the shared resource pool, wherein the shared resource pool is augmented in response to ascertained completion of objective(s) that must be completed to reach the finite resource cap. The request may include an indication of a contact from the list of recommended contacts to be included in the shared pool. The request can also include a name or label describing the pool and a goal date for accumulating sufficient resources for the finite resource cap to be reached. In an embodiment, the system has a limitation on the amount of concurrent resource pools a user can be associated with. In that embodiment, the system will query a user records log to ensure that the user request to create a shared pool of resources does not exceed the limitation for concurrent resource pools.

At block 620, the system receives, via the network, user request(s) from a plurality of users that include the at least one contact, the user request(s) initiating incorporating at least one of the plurality of users in the shared resource pool. In an embodiment, the system has a limitation on the amount of users associated with a single resource pool. In that embodiment, the system will query a user records log with every user request to ensure that the amount of users does not exceed the limitation. Accordingly, user request(s) received from the plurality of users is limited to a threshold of user requests.

At block 625, the system authenticates respective authentication credentials of the plurality of users by comparing the respective authentication credentials to stored user authentication credentials, and based thereon grants access to the shared resource pool. In an embodiment, the authentication process can be single-factor authentication of a username and password. In another embodiment, the authentication process can be multi-factor, including a username and password and a known trait of the user, such as a security question or PIN. In another embodiment, the authentication process can be biometric. Should the system fail to authenticate the authentication credentials of a user, the method will be terminated.

At block 630, the system maintains a user records log of user contributions to the objective(s). In addition to the enterprise system maintaining the user records log, the user records log can be stored locally in the user device. For example, user devices can locally maintain a user records log for a singular user signed in to the device. User records logs can record user actions not related to contributions to the pool, such as app usage over time, peak usage times, user activity patterns, or user-to-user interaction patterns.

At block 635, the system updates status data used to initiate display of a progress status indicator representing completion of the objective(s). The progress status bar indicating completion can be transmitted to the user device and the user device can initiate display to communicate status to the user. The progress status bar can indicate completion of the finite resource cap of the shared pool of resources, or it can indicate completion of the individual user's contributions to their portion of the shared pool of resources. The progress status bar can indicate personalized recommended steps to continue towards progression of the indicated goal.

At block 640, the system distributes, once the finite resource cap has been satisfied, resource(s) to user accounts of the plurality of users, the resource(s) that are distributed to each of the user accounts being less than the shared resources pool. In other words, no user would receive all of the resources from the resource pool as the resources from the resource pool would be distributed to more than one user account. In various embodiments, the distribution that is allotted each individual user may or may not be even for the same amount, depending on the proportions indicated, for example, in the distribution unit 285 of FIG. 2. Distribution of the resources can be dependent on validation that all users associated with the shared pool of resources are in good financial standing with the enterprise system. In an embodiment of the invention, distribution to all users will be halted if one user is not in good financial standing. Good financial standing can be defined by a given amount of outstanding debt, outstanding user support tickets, outstanding suspensions or bans on a user account, or other disciplinary actions taken against the user.

In some embodiments, the method 600 further includes identify each of the user accounts of the plurality of users associated with user contributions from the user records log. The method 600 can also include quantifying a total amount resources of the shared resource pool, the total amount of resources corresponding to the finite resource cap. Further, the method 600 may include partitioning the total amount of resources into equal distributions, and based thereon performing the distributing of the one or more resources in accordance with the equal distributions such that each of the user accounts receives an equal quantity of the one or more resources.

In some embodiments, the method 600 includes receiving, via the network, a display request from the user device to initiate display of one or more shared resource pools each having an associated finite resource cap, each of the one or more shared resource pools being associated with at least one contact ascertained from the list of recommended contacts. Further, information associated with the one or more shared resource pools may then be transmitted for display via the user device.

In some embodiments, the method 600 further includes receiving, from the user device, contact data corresponding to a new contact not previously included within the list of recommended contacts and based on the contact date correspondence is transmitted, via the network, to the new contact. The method may then include receiving, via the network, a response to the correspondence from the new contact, and based on the response the new contact is added to the list of recommended contacts. In some embodiments, adding the new contact to the list of recommended contacts includes one instance of the one or more objectives that would need to be completed by the user.

In some embodiments, the method 600 also includes receiving, from the user device, a removal request to remove one or more contacts from the list of recommended contacts. Also, the method may include removing, based on receiving the removal request, the one or more recommended contacts from the list of recommended contacts.

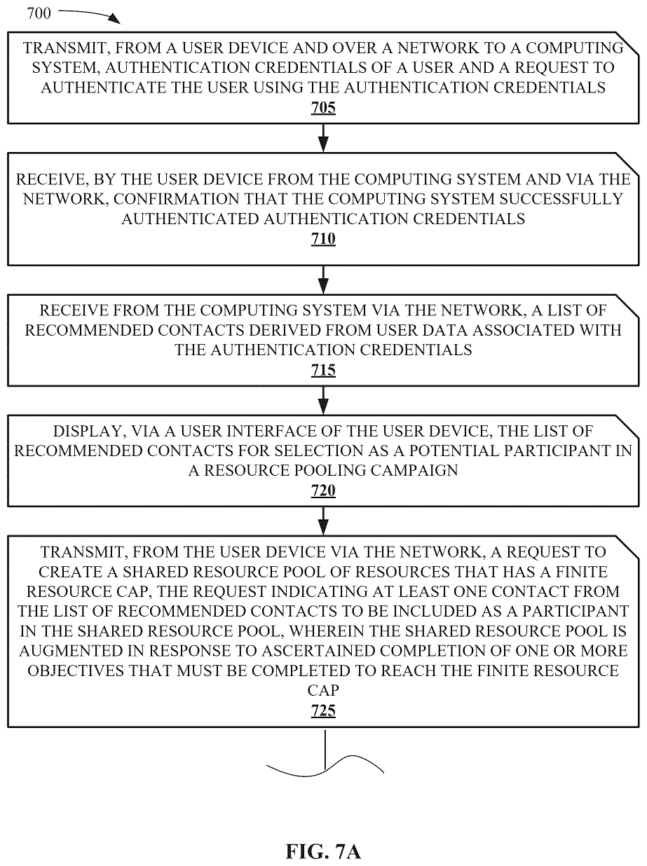

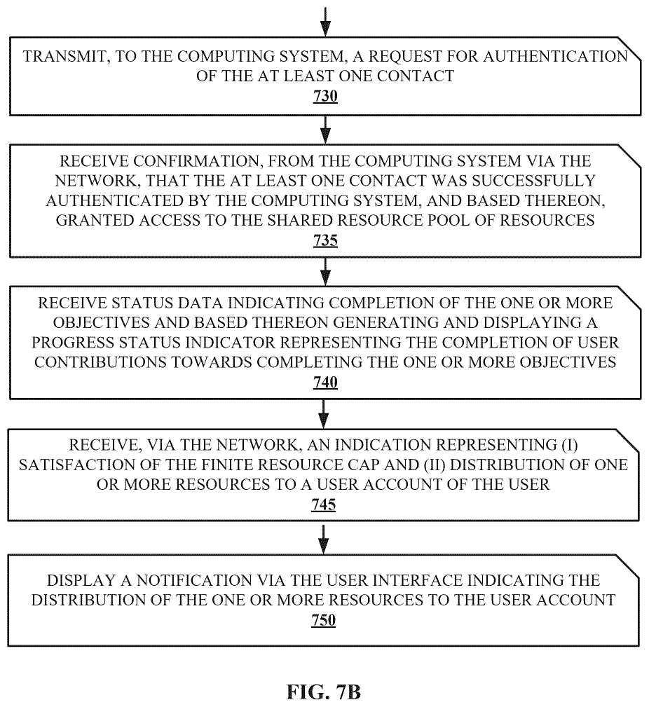

FIGS. 7A and 7B depict a block diagram of an example method 700. At block 705, the system transmits, from a user device and over a network to a computing system, authentication credentials of a user and a request to authenticate the user using the authentication credentials. In an embodiment, the authentication credentials can be single-factor authentication of a username and password. In another embodiment, the authentication credentials can be multi-factor, including a username and password and a known trait of the user, such as a security question or PIN. In another embodiment, the authentication credentials can be biometric.

At block 710, the system receives, by the user device from the computing system and via the network, confirmation that the computing system successfully authenticated authentication credentials. Should the system fail to authenticate the authentication credentials of a user, the method may be terminated, and a message may be sent to the user via the network informing them of the failed authentication process. Confirmation may be relayed to the user using the user device via a push notification, in-application pop-up message, or other form of communication.

At block 715, the system receives, from the computing system via the network, a list of recommended contacts derived from user data associated with the authentication credentials.

At block 720, the system displays, via a user interface of the user device, the list of recommended contacts for selection as potential participants in a resource pooling campaign. Users, via interaction with the user device, may select one or more recommended contact(s) from the list to create a shared resource pool with.

At block 725, the system transmits, from the user device via the network, a request to create a shared resource pool of resources that has a finite resource cap, the request indicating at least one contact from the list of recommended contacts to be included as a participant in the shared resource pool, wherein the shared resource pool is augmented in response to ascertained completion of one or more objectives that must be completed to reach the finite resource cap. Transmission of a request to create a shared pool of resources that has a finite resource cap may also include a label or name for the shared pool of resources, an indication of what resources are to be shared, the relationship between two users entering into the shared pool of resources, or other identifying information.

At block 730, the system transmits, the computing system, a request for authentication of the at least one contact.

At block 735, the system receives confirmation, from the computing system via the network, that the at least one contact was successfully authenticated by the computing system, and based thereon, grants access to the shared resource pool of resources. Should the system fail to authenticate the authentication credentials of an at least one contact, the method may be terminated, and a message may be sent to the user via the network informing them of the failed authentication process.

At block 740, the system receives status data indicating completion of the one or more objectives and based thereon generating and displaying a progress status indicator representing the completion of user contributions towards completing the one or more objectives. The progress status indicator may be displayed in combination with other elements (e.g. the label or name of the shared pool of resources, the participants, etc.)

At block 745, the system receives, via the network, an indication representing (i) satisfaction of the finite resource cap and (ii) distribution of one or more resources to a user account of the user. The indication may also be transmitted by the system via the network to the user to inform the user of the satisfaction of the finite resource cap.

At block 750, the system displays a notification via the user interface indicating the distribution of the one or more resources to the user account. According to various embodiments, notification can come in the form of a push notification, a short message service (SMS), or an email. In some embodiments, notifications are also sent to the contacts identified by the user to alert the contacts that the distribution has taken place.

In some embodiments, the method 700 also includes displaying, via the user interface, a contribution feed indicating one or more contributions from one or more contacts of the list of recommended contacts. In some embodiments, the method may also include receiving a user input to acknowledge at least one of the one or more contributions. In some embodiments, the system also transmits via the network, contact data corresponding to a new contact not previously included within the list of recommended contacts. In addition, the system receives, via the network, validation that the contact data corresponds to stored contact data associated with an individual identified by the contact data, and the system adds the new contact to the list of recommended contacts. The system may also initiate display, via the user device, of a confirmation of the new contact being added to the list of recommended contacts. In some embodiments, the method 700 may also include transmitting, over the network, a request to remove one or more contacts from the list of recommended contacts. Further, the method 700 may include receiving, via the network, and displaying a confirmation of removal of the one or more contacts from the list of recommended contacts.

Computer program instructions are configured to carry out operations of the present invention and may be or may incorporate assembler instructions, instruction-set-architecture (ISA) instructions, machine instructions, machine dependent instructions, microcode, firmware instructions, state-setting data, source code, and/or object code written in any combination of one or more programming languages. Aggregation systems used to aggregate data may standardize such data into a same programming language to facilitate data processing and interpretation. In addition, the systems disclosed herein may incorporate data cleaning and data compression to eliminate redundancies and enhance data collection processes.

An application program may be deployed by providing computer infrastructure operable to perform one or more embodiments disclosed herein by integrating computer readable code into a computing system thereby performing the computer-implemented methods disclosed herein.

Although various computing environments are described above, these are only examples that can be used to incorporate and use one or more embodiments. Many variations are possible.

The corresponding structures, materials, acts, and equivalents of all means or step plus function elements in the claims below, if any, are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to explain the principles of one or more aspects of the invention and the practical application thereof, and to enable others of ordinary skill in the art to understand one or more aspects of the invention for various embodiments with various modifications as are suited to the particular use contemplated.

It is to be noted that various terms used herein such as “Linux®”, “Windows®”, “macOS®”, “iOS®”, “Android®”, and the like may be subject to trademark rights in various jurisdictions throughout the world and are used here only in reference to the products or services properly denominated by the marks to the extent that such trademark rights may exist.

What is claimed is:

1. A computing system for secure privileged user resource access authentication, the system comprising:
at least one processor;
a communication interface communicatively coupled to the at least one processor; and
a memory device storing executable code that, when executed, causes the at least one processor to:
receive and validate authentication credentials of a user by comparing the authentication credentials to stored authentication credentials;
generate and transmit to a user device, a list of recommended contacts for display, the list of recommended contacts being derived from stored user data associated with the stored authentication credentials;
receive, via a network and from the user device, a request to create a shared resource pool of resources that has a finite resource cap, the request indicating at least one contact from the list of recommended contacts transmitted to the user device that is to be included as a participant in the shared resource pool, wherein the shared resource pool is augmented in response to ascertained completion of one or more objectives that must be completed to reach the finite resource cap;
receive, via the network, one or more user requests from a plurality of users that include the at least one contact, the one or more user requests initiating incorporating of the plurality of users in the shared resource pool;
authenticate respective authentication credentials of the plurality of users by comparing the respective authentication credentials to stored user authentication credentials, and based thereon grant access to the shared resource pool;
maintain a user records log of user contributions for completing the one or more objectives;
update status data, that status data being used to initiate display of a progress status indicator representing completion of the one or more objectives; and
distribute, once the finite resource cap is satisfied, one or more resources to user accounts of the plurality of users, the one or more resources that are distributed to each of the user accounts being less than the shared resource pool.

2. The computing system according to claim 1, wherein the executable code, when executed, further causes the at least one processor to:
identify each of the user accounts of the plurality of users associated with user contributions from the user records log;
quantify a total amount resources of the shared resource pool, the total amount of resources corresponding to the finite resource cap; and
partition the total amount of resources into equal distributions, and based thereon performing the distributing of the one or more resources in accordance with the equal distributions such that each of the user accounts receives an equal quantity of the one or more resources.

3. The computing system according to claim 1, wherein the one or more user requests received from the plurality of users is limited to a threshold of user requests.

4. The computing system according to claim 1, wherein the executable code, when executed, further causes the at least one processor to:
receive, via the network, a display request from the user device to initiate display of one or more shared resource pools each having an associated finite resource cap, each of the one or more shared resource pools being associated with at least one contact ascertained from the list of recommended contacts; and
transmit for display, via the user device, information associated with the one or more shared resource pools.

5. The computing system according to claim 1, wherein the executable code, when executed, further causes the at least one processor to:
receive, from the user device, contact data corresponding to a new contact not previously included within the list of recommended contacts;
based on the contact data, transmit, via the network, correspondence to the new contact;
receive, via the network, a response to the correspondence from the new contact; and
based on the response, add the new contact to the list of recommended contacts.

6. The computing system according to claim 5, wherein adding the new contact to the list of recommended contacts comprises one instance of the one or more objectives to be completed.

7. The computing system according to claim 1, wherein the executable code, when executed, further causes the at least one processor to:
receive, from the user device, a removal request to remove one or more contacts from the list of recommended contacts; and
remove, based on receiving the removal request, the one or more recommended contacts from the list of recommended contacts.

8. A computer-implemented method, comprising:
receiving and validating authentication credentials of a user by comparing the authentication credentials to stored authentication credentials;
generating and transmitting to a user device a list of recommended contacts for display, the list of recommended contacts being generated in response to stored user data associated with the stored authentication credentials;
receiving, via a network from the user device, a request to create a shared resource pool of resources that has a finite resource cap, the request indicating at least one contact from the list of recommended contacts transmitted to the user device that is to be included as a participant in the shared pool, wherein the shared resource pool is augmented in response to ascertained completion of one or more objectives that must be completed to reach the finite resource cap;
receiving, via the network, one or more user requests from a plurality of users that include the at least one contact, the one or more user requests initiating incorporating of the plurality of users in the shared resource pool;
authenticating respective authentication credentials of the plurality of users by comparing the respective authentication credentials to stored user authentication credentials, and based thereon grant access to the shared resource pool;
maintaining a user records log of user contributions for completing the one or more objectives;
updating status data used to initiate display of a progress status indicator representing completion of the one or more objectives; and
distributing, once the finite resource cap is satisfied, one or more resources to user accounts of the plurality of users, the one or more resources that are distributed to each of the user accounts being less than the shared resource pool.

9. The computer-implemented method according to claim 8, further comprising:
identifying each of the user accounts of the plurality of users associated with user contributions from the user records log;
quantifying a total amount resources of the shared resource pool, the total amount of resources corresponding to the finite resource cap; and
partitioning the total amount of resources into equal distributions, and based thereon performing the distributing of the one or more resources in accordance with the equal distributions such that each of the user accounts receives an equal quantity of the one or more resources.

10. The computer-implemented method according to claim 8, wherein the one or more user requests received from the plurality of users is limited to a threshold of user requests.

11. The computer-implemented method according to claim 8, further comprising:
receiving, via the network, a display request from the user device to initiate display of one or more shared resource pools each having an associated finite resource cap, each of the one or more shared resource pools being associated with at least one contact ascertained from the list of recommended contacts; and
transmitting for display, via the user device, information associated with the one or more shared resource pools.

12. The computer-implemented method according to claim 8, further comprising:
receiving, from the user device, contact data corresponding to a new contact not previously included within the list of recommended contacts;
based on the contact data, transmitting, via the network, correspondence to the new contact;
receiving, via the network, a response to the correspondence from the new contact; and
based on the response, adding the new contact to the list of recommended contacts.

13. The computer-implemented method according to claim 12, wherein adding the new contact to the list of recommended contacts comprises one instance of the one or more objectives to be completed.

14. The computer-implemented method according to claim 8, further comprising:
receiving, from the user device, a removal request to remove one or more contacts from the list of recommended contacts; and
removing, based on receiving the removal request, the one or more recommended contacts from the list of recommended contacts.

15. A computer-implemented method, comprising:
transmitting, from a user device and over a network to a computing system, authentication credentials of a user and a request to authenticate the authentication credentials;
receiving, by the user device from the computing system and via the network, confirmation that the computing system successfully authenticated the authentication credentials;
receiving from the computing system via the network, a list of recommended contacts derived from user data associated with the authentication credentials;
displaying, via a user interface of the user device, the list of recommended contacts for selection as a potential participant in a resource pooling campaign;
transmitting, from the user device via the network, a request to create a shared resource pool of resources that has a finite resource cap, the request indicating at least one contact from the list of recommended contacts to be included as a participant in the shared resource pool, wherein the shared resource pool is augmented in response to ascertained completion of one or more objectives that must be completed to reach the finite resource cap;
transmitting, to the computing system, a request for authentication of the at least one contact;
receiving confirmation, from the computing system via the network, that the at least one contact was successfully authenticated by the computing system, and based thereon, granted access to the shared resource pool of resources;
receiving status data indicating completion of the one or more objectives and based thereon generating and displaying a progress status indicator representing the completion of user contributions towards completing the one or more objectives;
receiving, via the network, an indication representing (i) satisfaction of the finite resource cap and (ii) distribution of one or more resources to a user account of the user; and
displaying a notification via the user interface indicating the distribution of the one or more resources to the user account.

16. The computer-implemented method according to claim 15, further comprising displaying, via the user interface, a contribution feed indicating one or more contributions from one or more contacts of the list of recommended contacts.

17. The computer-implemented method according to claim 16, further comprising receiving a user input to acknowledge at least one of the one or more contributions.

18. The computer-implemented method according to claim 15, further comprising:
transmitting, via the network, contact data corresponding to a new contact not previously included within the list of recommended contacts;
receiving, via the network, validation that the contact data corresponds to stored contact data associated with an individual identified by the contact data;
adding the new contact to the list of recommended contacts; and
initiating display, via the user device, of a confirmation of the new contact being added to the list of recommended contacts.

19. The computer-implemented method according to claim 18, wherein adding the new contact to the list of recommended contacts comprises one instance of the one or more objectives to be completed.

20. The computer-implemented method according to claim 15, further comprising:
transmitting, via the network, a request to remove one or more contacts from the list of recommended contacts; and
receiving, via the network, and displaying a confirmation of removal of the one or more contacts from the list of recommended contacts.
